(19) United States
(12) Patent Application Publication
(10) Pub. No.: US 2009/0015518 A1
(43) Pub. Date: Jan. 15, 2009

(54) Plasma display panel

(76) Inventor: Jung-Suk Song, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/216,592

(22) Filed: Jul. 8, 2008

(30) Foreign Application Priority Data
Jul. 10, 2007 (KR) 10-2007-0069354

(51) Int. Cl. G09G 3/28

(52) U.S. Cl. 345/60

(57) ABSTRACT

A plasma display panel includes a substrate, a plurality of first electrodes on the substrate, the first electrodes having a first length and being on a first plane, a plurality of second electrodes on the substrate, the second electrodes having a second length and being on a second plane, the second length being different than the first length, and the second plane being different than the first plane, and a plurality of dielectric layers on the substrate, the dielectric layers embedding the first and second electrodes.

### CROSS-REFERENCE TO RELATED APPLICATION

The present application is a related application of a co-pending U.S. patent application Ser. No. 12/071,975, entitled “Plasma Display Panel,” which was filed on Feb. 28, 2008, and is incorporated by reference herein in its entirety.

### BACKGROUND OF THE INVENTION

1. Field of the Invention

Embodiments of the present invention relate to a plasma display panel (PDP). More particularly, embodiments of the present invention relate to a PDP having electrodes with different lengths on different planes.

2. Description of the Related Art

A PDP may refer to a flat panel display device displaying images via a gas discharge phenomenon. For example, the PDP may include a discharge gas between two substrates, so application of a voltage via a plurality of discharge electrodes to the discharge gas may generate a discharge. The discharge may trigger ultraviolet (UV) light to excite phosphor layers to emit visible light.

The conventional discharge electrodes may include electrode terminals formed of silver to facilitate connection to a signal transmission unit. However, silver may be ionized by moisture in the atmosphere, and may trigger electron and/or material migration from one electrode to another. Such an electron migration may reduce distance between adjacent electrode terminals, thereby causing short-circuits therebetween and display defects, e.g., a vertical line defect in a displayed image.

### SUMMARY OF THE INVENTION

Embodiments of the present invention are therefore directed to a PDP, which substantially overcomes one or more of the disadvantages of the related art.

It is therefore a feature of an embodiment of the present invention to provide a PDP having a structure capable of minimizing shorting between adjacent discharge electrodes.

At least one of the above and other features and advantages of the present invention may be realized by providing a PDP, including a substrate, a plurality of first electrodes on the substrate, the first electrodes having a first length and being on a first plane, a plurality of second electrodes on the substrate, the second electrodes having a second length and being on a second plane, the second length being different than the first length, and the second plane being different than the first plane, and a plurality of dielectric layers on the substrate, the dielectric layers embedding the first and second electrodes.

At least one dielectric layer of the plurality of dielectric layers may be between the plurality of first electrodes and the plurality of second electrodes. The plurality of dielectric layers may include first and second dielectric layers on the substrate, the first electrodes being embedded in the first dielectric layer, and the second electrodes being embedded in the second dielectric layer. The first electrodes may be between the substrate and the first dielectric layer, and the second electrodes may be between the first dielectric layer and the second dielectric layer. The first and second electrodes may have an alternating array pattern. The first electrodes may define odd-numbered electrodes on the substrate, and the second electrodes may define even-numbered electrodes on the substrate. The first electrodes may be longer than the second electrodes. The first dielectric layer may be wider than the second dielectric layer. The first and second electrodes may be address electrodes. The first and second electrodes may be sustain discharge electrodes.

The PDP may further include a signal transmitter, the signal transmitter having lead terminals electrically connected to the first and second electrodes. The lead terminals may be positioned to correspond to terminals of the first and second electrodes. The signal transmitter may include leads embedded in a flexible film, terminals of the leads being exposed externally to correspond to the terminals of the first and second electrodes. The terminals of the leads may include first lead terminals connected to terminals of the first electrodes and second lead terminals connected to terminals of the second electrodes. The first and second lead terminals may be arranged at different distances from an edge of the flexible film. The second lead terminals may be closer to the edge of the flexible film than the first lead terminals.

At least one of the above and other features and advantages of the present invention may be also realized by providing a PDP, including first and second substrates facing one another, a plurality of first and second discharge electrodes on the first substrate, a plurality of first address electrodes on the second substrate, the first address electrodes having a first length and being on a first plane, a plurality of second address electrodes on the second substrate, the second address electrodes having a second length and being on a second plane, the second length being different than the first length, and the second plane being different than the first plane, a plurality of dielectric layers on the substrate, the dielectric layers embedding the first and second electrodes, and a signal transmitter electrically connected to the first and second address electrodes.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partial perspective view of a PDP according to an embodiment of the present invention;

FIG. 2 illustrates a plan view of a connection of the PDP of FIG. 1 to a driving circuit board through a signal transmitter;

FIG. 3 illustrates a plan view of a connection of electrode terminals to a signal transmitter according to an embodiment of the present invention; and

FIG. 4 illustrates a perspective view of FIG. 3.

### DETAILED DESCRIPTION OF THE INVENTION

Korean Patent Application No. 10-2007-0069354, filed on Jul. 10, 2007, in the Korean Intellectual Property Office, and entitled: “PDP Having Discharge Electrodes Having Different Lengths,” is incorporated by reference herein in its entirety.

Exemplary embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers or elements may also be present. Further, it will be understood that the term “on” can indicate solely a vertical arrangement of one element or layer with respect to another element or layer, and may not indicate a specific vertical orientation. In addition, it will also be understood that when a layer is referred to as being “between” two layers, it can be the only layer between the two layers, or one or more intervening layers may also be present. Like reference numerals refer to like elements throughout.

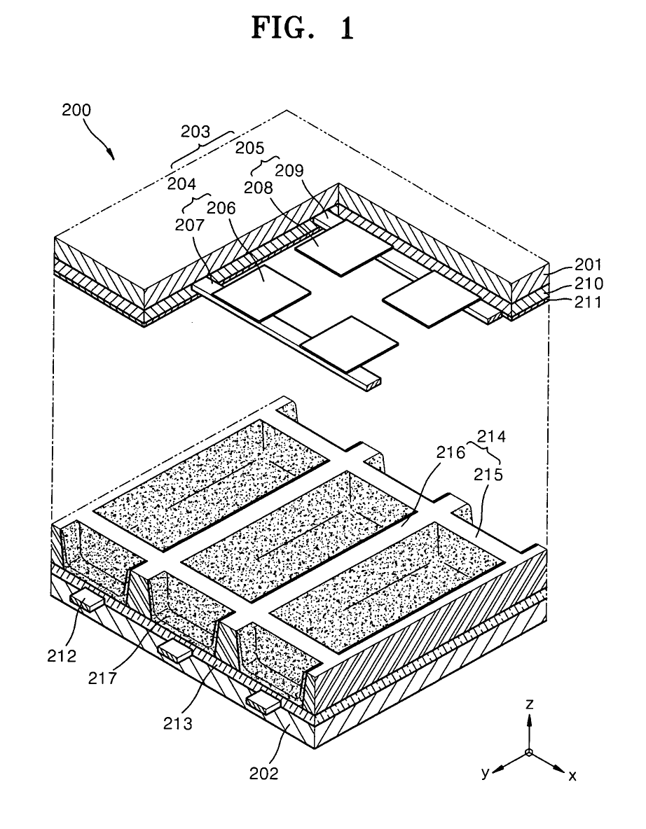

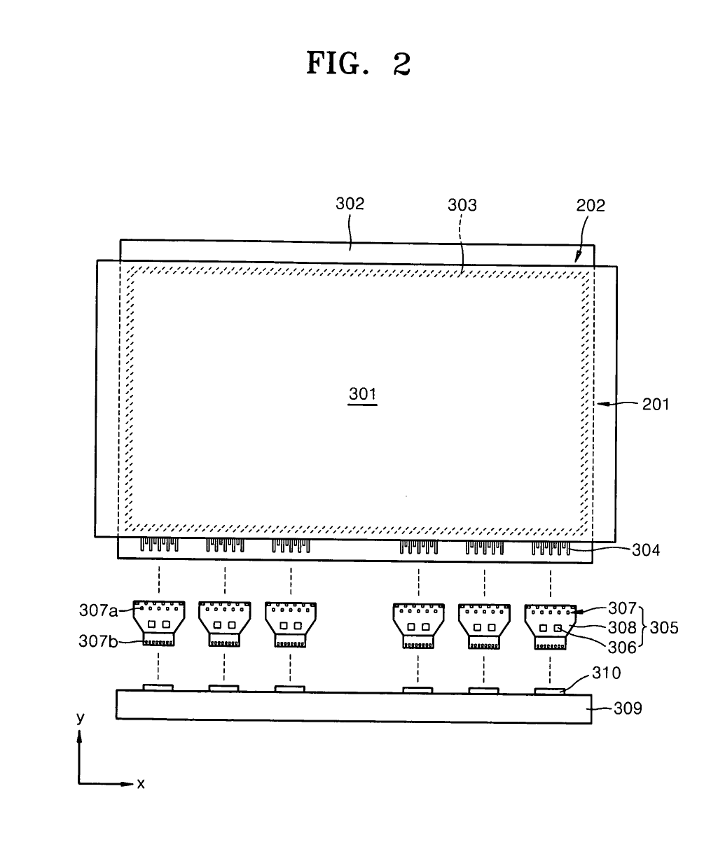

FIG. 1 illustrates a partial perspective view of a PDP, e.g., a 3-electrode surface discharge type PDP, according to an exemplary embodiment of the present invention. Referring to FIG. 1, a PDP 200 may include a first substrate 201 and a second substrate 202 disposed parallel to the first substrate 201. Each one of the first and second substrates 201 and 202 may be any one of a transparent substrate, e.g., formed of soda lime glass, a semi-permeable substrate, a reflective substrate, or a colored substrate. A frit glass layer 303, as illustrated in FIG. 2, may be applied to peripheral areas of inner surfaces of the first and second substrates 201 and 202 to connect therebetween in order to form a sealed space between the first and second substrates 201 and 202. The sealed space, i.e., a display area 301 illustrated in FIG. 2, may include functional elements, e.g., sustain discharge electrodes 203 and discharge cells, and may provide display functions. In this respect, it should be noted that “inner surfaces” may refer to surfaces facing the sealed space.

The sustain discharge electrodes 203 of the PDP 200 may be in the display area 301, i.e., on an inner surface of the first substrate 201. As illustrated in FIG. 1, each pair of sustain discharge electrodes 203 may include an X electrode 204 and a Y electrode 205, so a pair of the X electrode 204 and the Y electrode 205 may be disposed along an array of discharge cells along the x-axis. Each X electrode 204 may include a first bus electrode line 207 along the x-axis and a plurality of transparent electrodes 206 electrically connected to the first bus electrode line 207. Each transparent electrode 206 may be independently disposed in each discharge cell in the array of discharge cells corresponding to the first bus electrode line 207. Each Y electrode 205 may include a plurality of second transparent electrodes 208 independently disposed in each discharge cell and electrically connected to a second bus electrode line 209. The second bus electrode line 209 may be parallel to the first bus electrode line 207.

The first bus electrode line 207 and the second bus electrode line 209 may be positioned along edges of facing sides of the discharge cells, and may have an alternating stripe pattern. Accordingly, a pair of first and second transparent electrodes 206 and 208 may be positioned in each discharge cell along the first and second bus electrode lines 207 and 209, such that the first and second transparent electrodes 206 and 208 may be spaced apart from each other at a predetermined interval. The predetermined interval may correspond to a center of each discharge cell in order to form a discharge gap.

A cross section of each of the first transparent electrodes 206 and the second transparent electrodes 208 may have any suitable shape, e.g., a quadrangle. The first transparent electrodes 206 and the second transparent electrodes 208 may be formed of a transparent material, e.g., an indium-tin-oxide (ITO) film, and the first bus electrode lines 207 and the second bus electrode lines 209 may be formed of a metal having excellent conductivity, e.g., a silver paste, chrome-copper-chrome layer, and so forth.

The X electrode 204 and the Y electrode 205 may be embedded in a first dielectric layer 210. The first dielectric layer 210 may be formed using a transparent dielectric substance having high dielectric properties, e.g., PbO—B₂O₃—SiO₂. A protective layer 211 may be formed, e.g., of magnesium oxide (MgO), on the first dielectric layer 210 in order to increase secondary electron emission.

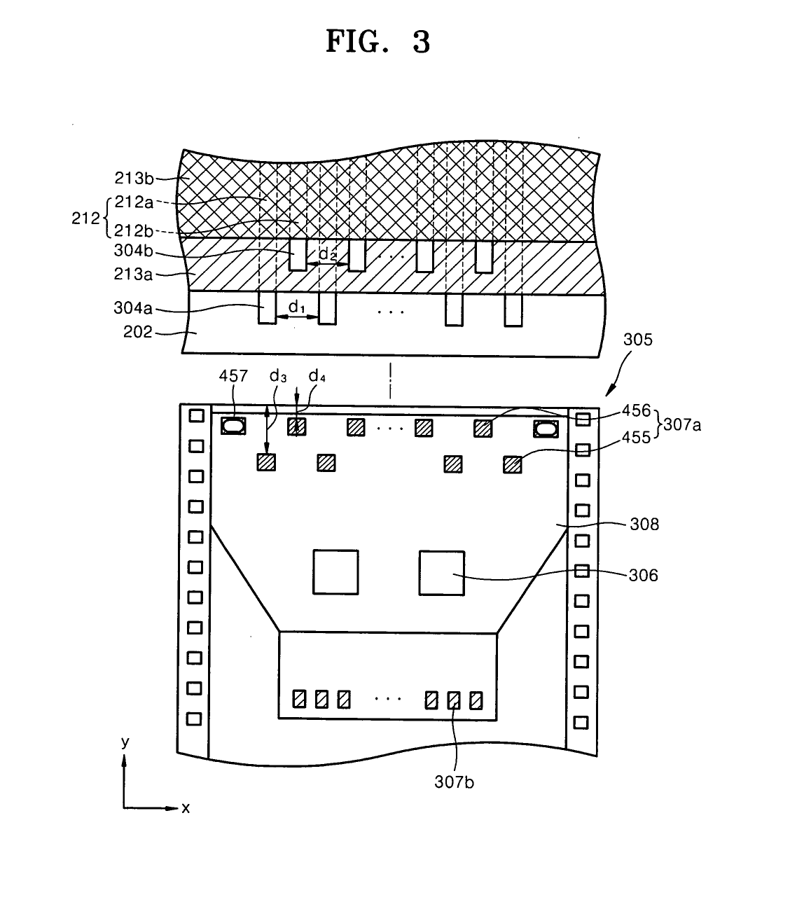

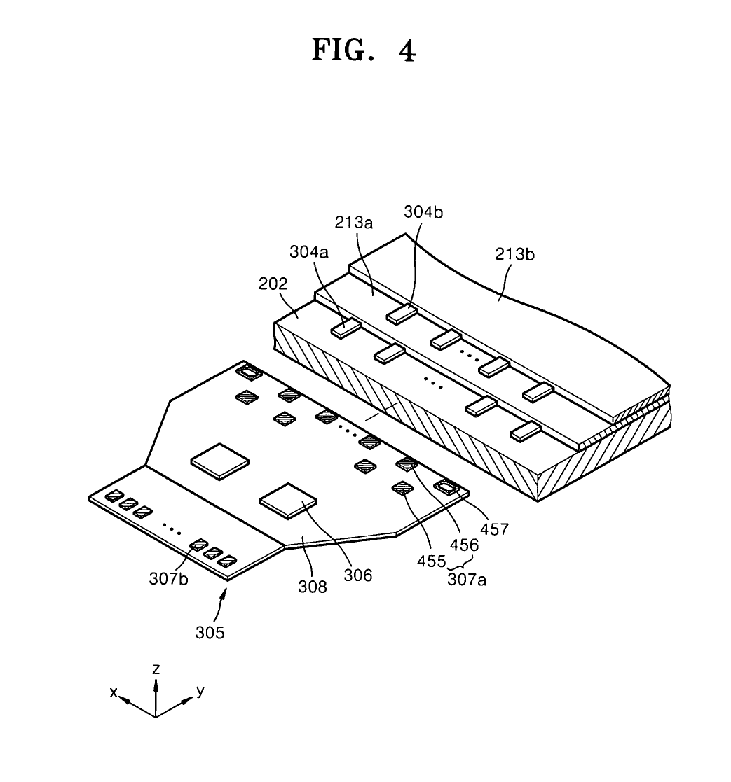

The PDP 200 may further include address electrodes 212 on an inner surface, i.e., a surface facing the discharge cells, of the second substrate 202. The address electrodes 212, as illustrated in FIG. 1, may extend along respective arrays of discharge cells along the y-axis, i.e., each address electrode 212 may extend along a single array of discharge cells. The address electrodes 212 may cross the discharge electrodes 203, and may have a stripe pattern. The address electrodes 212 may include a plurality of first address electrodes 212a and a plurality of second address electrodes 212b performing address discharge, as illustrated in FIGS. 3-4. The first and second address electrodes 212a and 212b may have different lengths, and may be positioned on different planes, as will be discussed in more detail below with reference to FIGS. 3-4. A second dielectric layer 213 may be formed on the second substrate 202 of a material having high dielectric properties, e.g., may be substantially similar to the first dielectric layer 210, and may include at least a first dielectric portion 213a and a second dielectric portion 213b, as will be discussed in more detail below with reference to FIGS. 3-4.

The PDP 200 may further include barrier ribs 214, as illustrated in FIG. 1, between the first and second substrates 201 and 202. The barrier ribs 214 may define the discharge cells, and may prevent cross talk between adjacent discharge cells. The barrier ribs 214 may include first barrier ribs 215 along the x-axis and second barrier ribs 216 along the y-axis. The barrier ribs 214 may define the discharge cells to have a lattice pattern and any suitable cross-section, e.g., a polygon, a quadrangle, a circle, an oval, and so froth. Discharge gas, e.g., neon (Ne), xenon (Xe), helium (He), or a combination thereof, may be injected into the discharge cells.

The PDP 200 may further include phosphor layers 217 to emit visible light when excited by UV light generated by the discharge gas. The phosphor layers 217 may be formed inside the discharge cells, e.g., may be coated on any area of the discharge cells. For example, the phosphor layers 217 may be formed on an inner surface of the second dielectric layer 213 and/or on sidewalls of the barrier ribs 214. The phosphor layers 217 may include red phosphor, e.g., (Y,Gd)BO₃; Eu⁺³, green phosphor, e.g., Zn₂SiO₄:Mn²⁺, and/or blue phosphor, e.g., BaMgAl₁₀O₁₇:Eu²⁺.

As illustrated in FIG. 2, the first substrate 201 may be shorter than the second substrate 202, e.g., along the y-axis. Accordingly, the display area 301 may include only an area formed by an overlap of the first and second substrates 201 and 202. Portions of the second substrate 202 extending, e.g., along the y-axis, beyond the first substrate 201 may be referred to as a non-display area 302, and may include electrode terminals 304 of the discharge electrodes 203 or of the address electrodes 212. The non-display area 302 may be a peripheral area in communication with at least one edge of the display area 301 to expose the electrode terminals 304, thereby facilitating electrical connection thereof to a driving circuit board 309 via a signal transmitter 305, as illustrated in FIG. 2. The PDP 100 may include a plurality of non-display areas 302, i.e., the second substrate 202 may extend beyond more than a single edge of the first substrate 201.

The electrode terminals 304 may extend on an upper surface of the second substrate 202 along the y-axis, and may be arranged in a stripe-pattern along the x-axis in the non-display area 302, as illustrated in FIG. 2. The electrode terminals 304 may have a structure of group units. In other words, the electrode terminals 304 may be arranged into a plurality of group units spaced apart from each other, each group unit having a plurality of electrode terminals 304, as illustrated in FIG. 2. A single group unit of electrode terminals 304 may be separately connected to a single signal transmitter 305. Accordingly, a large size of the PDP 200 may require a plurality of signal transmitters 305 connected to a plurality of electrode terminals 304 arranged into a plurality of group units. The electrode terminals 304 may not be covered by the second dielectric layer 213 and/or by the first dielectric layer 210 to facilitate electrical connection between the electrode terminals 304 and the signal transmitters 305. The electrode terminals 304 may be disposed on different planes, as will be discussed in more detail below with reference to FIG. 3.

The signal transmitter 305 of the PDP 200 may be formed in any suitable shape, and may be connected to the electrode terminals 304, as illustrated in FIG. 2, to drive the PDP 200. More specifically, the signal transmitter 305 may be connected between the electrode terminals 304 and the driving circuit unit 309 to transmit electric signals therebetween. The signal transmitter 305 may include a plurality of driving integrated circuits (ICs) 306, a plurality of leads 307 patterned to be connected to the driving ICs 306, and a flexible film 308 covering the leads 307. The leads 307 may be disposed on portions to correspond to the electrode terminals 304 in order to be electrically connected thereto, i.e., form an electrical connection between the signal transmitter 305 and the electrode terminals 304. The leads 307 may be electrically connected to the electrode terminals 304 via first lead terminals 307a, i.e., terminals formed at a first edge of the flexible film 308. A connector 310 may form an electrical connection between the signal transmitter 305 and the driving circuit unit 309 via second lead terminals 307b, i.e., terminals formed at a second edge of the flexible film 308 opposite the first edge.

The connection between the electrode terminals 304 and the signal transmitters 305 will be described in more detail below with reference to FIGS. 3-4. FIG. 3 illustrates an enlarged plan view of the first and second address electrodes 212a and 212b and the signal transmitter 305, and FIG. 4 illustrates a perspective view of FIG. 3. It is noted that even though first and second address electrodes 212a and 212b are illustrated in FIGS. 3-4 as having different lengths and being positioned on different planes, other electrodes, e.g., sustain discharge electrodes 203 performing sustain discharge and/or any other electrodes of a PDP, may be configured in a substantially same arrangement.

Referring to FIGS. 3-4, the first and second address electrodes 212a and 212b may be embedded in a plurality of first and second dielectric portions 213a and 213b on the second substrate 202. The plurality of first and second address electrodes 212a and 212b may be on first and second planes, respectively, to form a multi-layered structure of first and second address electrodes 212a and 212b separated by first and second dielectric portions 213a and 213b. The first and second planes may both be horizontal planes, i.e., in the xy-plane, but the first and second planes may have different vertical positions along the z-axis. Accordingly, the first address electrodes 212a may have a different vertical position along the z-axis, as compared to the second address electrodes 212b.

More specifically, the first address electrodes 212a may extend along the y-axis on the second substrate 202, and may have a stripe pattern along the x-axis, as illustrated in FIG. 3. The first address electrodes 212a may have a first interval d1 therebetween, as measured along the x-axis. A predetermined length of the first address electrodes 212a may be embedded in the first dielectric portion 213a, so first electrode terminals 304a of the first address electrodes 212a may be exposed, i.e., not embedded in the first dielectric portion 213a. The second address electrodes 212b may extend along the y-axis on the first dielectric portion 213a, and may have a stripe pattern along the x-axis, as further illustrated in FIG. 3. The second address electrodes 212b may have a second interval d2 therebetween, as measured along the x-axis. A predetermined length of the second address electrodes 212b may be embedded in the second dielectric portion 213b, so second electrode terminals 304b of the second address electrodes 212b may be exposed, i.e., not embedded in the second dielectric portion 213b.

The first address electrodes 212a may be disposed between the second substrate 202 and the first dielectric portion 213a, e.g., may be embedded within the first dielectric portion 213a. Accordingly, the first electrode terminals 304a may be exposed on the second substrate 202, and may have the first intervals d1 therebetween. The second discharge electrodes 212b may be disposed between the first dielectric portion 213a and the second dielectric portion 213b, e.g., may be embedded within the second dielectric portion 213b. Accordingly, the second electrode terminals 304b may be exposed on the first dielectric portion 213a, and may have the second intervals d2 therebetween.

The second address electrodes 212b may be disposed between the first address electrodes 212a to form an alternating array of multi-layered first and second address electrodes 212a and 212b. For example, the first address electrodes 212a may be disposed in odd columns on the first planes and the second address electrodes 212b may be disposed in even columns on the second plane. As such, the first and second electrode terminals 304a and 340b may form an alternating array of multi-layered first and second electrode terminals 304a and 340b, so a distance between two adjacent first and second electrode terminals 304a and 304b may be diagonal, i.e., may have both vertical and horizontal components. The horizontal component of the diagonal distance may equal about half the first or second intervals d1 and d2.

The first and second address electrodes 212a and 212b may have different lengths. More specifically, the first address electrodes 212a may be longer that the second address electrodes 212b along the y-axis. Further, the first dielectric layer 213a may be wider than the second dielectric layer 213b along the y-axis in order to form areas in which the first and second electrode terminals 304a and 304b may be exposed externally. Accordingly, the first electrode terminals 304a may be disposed closer to an edge of the second substrate 202, as compared to the second electrode terminals 304b. As such, the signal transmitter 305 may be electrically connected to the first address electrodes 212a and the second address electrodes 212b at the interval d1 between the first address electrodes 212a disposed in odd columns or the interval d2 between the second address electrodes 212b disposed in even columns. Therefore, the first lead terminals 307a of the signal transmitter 305 may be arranged at a configuration corresponding to the first and second electrode terminals 304a and 304b.

More specifically, as illustrated in FIG. 3, the first lead terminals 307a may be exposed externally on an edge of the flexible film 308 to facilitate electrical connection to the first and second electrode terminals 304a and 304b of the first and second address electrodes 212a and 212b, respectively. The leads 307 (not shown) may be embedded in the flexible film 308. The first lead terminals 307a may be formed on a same plane or not, and may be arranged at different locations of the flexible film 308 to correspond to the first and second terminals 304a and 304b. In other words, the first lead terminals 307a may include first terminals 455 electrically connected to the first electrode terminals 304a of the first address electrodes 212a, and second terminals 456 electrically connected to the second electrode terminals 304b of the second address electrodes 212b. The first and second terminals 455 and 456 may be positioned at different distances from an edge of the flexible film 308 along the y-axis. Mores specifically, a third interval d3 between the first terminals 455 and a front edge of the flexible film 308 may be longer than a fourth interval d4 between the second terminals 456 and the front edge of the flexible film 308, as illustrated in FIG. 3.

The first and second address electrodes 212a and 212b may be attached to the signal transmitter 305 as follows. First, the first address electrodes 212a disposed in odd columns on the second substrate 202 may be patterned. After the first address electrodes 212a are patterned, the first dielectric portion 213a may be deposited on an entire area of the second substrate 202, such that the first address electrodes 212a may be embedded. It is noted that the first electrode terminals 304a may not be embedded by the first dielectric portion 213a.

Then, the second address electrodes 212b disposed in even columns on the first dielectric portion 213a may be patterned. After the second address electrodes 212b are patterned, the second dielectric portion 213b may be deposited on an entire area of the first dielectric portion 213a, such that the second address electrodes 212a may be embedded. It is noted that the second electrode terminals 304b may not be embedded by the second dielectric portion 213b. An entire width of the second dielectric layer 213b may be narrower than an entire width of the first dielectric layer 213a along the y-axis. As described above, the first and second address electrodes 212a and 212b may be formed on different planes in a multi-layered structure.

Next, the signal transmitter 305 may be arranged on the second substrate 202, so the first and second electrode terminals 304a and 340b may respectively correspond to the first and second lead terminals 455 and 456 of the signal transmitter 305. More specifically, an alignment mark 457 formed on the flexible film 308 may be set to mutually overlap with a recognition unit (not shown) formed on the second substrate 202 to facilitate alignment therebetween, so the first and second terminals 340a and 304b may be connected to desired locations on the first and second lead terminals 455 and 456. When the locations of the first and second lead terminals 455 and 456, corresponding to the first and second electrode terminals 304a and 304b, are determined via the above process, an anisotropic conductive film (ACF) (not shown) may be applied between the first electrode terminals 304a and the first lead terminals 455, and between the second electrode terminals 304b and the second lead terminals 456, in order to electrically connect the terminals via heat sealing.

As described above, a PDP according to embodiments of the present invention may be advantageous in providing electrodes, e.g., address electrodes, having different lengths on different planes, so distances between the adjacent electrodes may be increased. Accordingly, upon connection of a signal transmitter to the electrodes, shorting between adjacent electrodes may be prevented or substantially minimized. Also, as a size of the PDP increases, an interval for preventing a vertical line defect of the discharge electrodes may be obtained between the terminals.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
a substrate;
a plurality of first electrodes on the substrate, the first electrodes having a first length and being on a first plane;
a plurality of second electrodes on the substrate, the second electrodes having a second length and being on a second plane, the second length being different than the first length, and the second plane being different than the first plane; and
a plurality of dielectric layers on the substrate, the dielectric layers embedding the first and second electrodes.

2. The PDP as claimed in claim 1, wherein at least one dielectric layer of the plurality of dielectric layers is between the plurality of first electrodes and the plurality of second electrodes.

3. The PDP as claimed in claim 1, wherein the plurality of dielectric layers includes first and second dielectric layers on the substrate, the first electrodes being embedded in the first dielectric layer, and the second electrodes being embedded in the second dielectric layer.

4. The PDP as claimed in claim 3, wherein the first electrodes are between the substrate and the first dielectric layer, and the second electrodes are between the first dielectric layer and the second dielectric layer.

5. The PDP as claimed in claim 3, wherein the first and second electrodes have an alternating array pattern.

6. The PDP as claimed in claim 5, wherein the first electrodes define odd-numbered electrodes on the substrate and the second electrodes define even-numbered electrodes on the substrate.

7. The PDP as claimed in claim 3, wherein the first electrodes are longer than the second electrodes.

8. The PDP as claimed in claim 3, wherein the first dielectric layer is wider than the second dielectric layer.

9. The PDP as claimed in claim 3, wherein the first and second electrodes are address electrodes.

10. The PDP as claimed in claim 3, wherein the first and second electrodes are sustain discharge electrodes.

11. The PDP as claimed in claim 1, further comprising a signal transmitter, the signal transmitter including lead terminals electrically connected to the first and second electrodes.

12. The PDP as claimed in claim 11, wherein the lead terminals are positioned to correspond to terminals of the first and second electrodes.

13. The PDP as claimed in claim 12, wherein the signal transmitter includes leads embedded in a flexible film, terminals of the leads being exposed externally to correspond to the terminals of the first and second electrodes.

14. The PDP as claimed in claim 13, wherein the terminals of the leads include first lead terminals connected to terminals of the first electrodes and second lead terminals connected to terminals of the second electrodes.

15. The PDP as claimed in claim 14, wherein the first and second lead terminals are arranged at different distances from an edge of the flexible film.

16. The PDP as claimed in claim 15, wherein the second lead terminals are closer to the edge of the flexible film than the first lead terminals.

17. A plasma display panel (PDP), comprising:
first and second substrates facing one another;
a plurality of first and second discharge electrodes on the first substrate;
a plurality of first address electrodes on the second substrate, the first address electrodes having a first length and being on a first plane;
a plurality of second address electrodes on the second substrate, the second address electrodes having a second length and being on a second plane, the second length being different than the first length, and the second plane being different than the first plane;
a plurality of dielectric layers on the substrate, the dielectric layers embedding the first and second electrodes; and
a signal transmitter electrically connected to the first and second address electrodes.

18. The PDP as claimed in claim 17, wherein the plurality of dielectric layers includes first and second dielectric layers on the substrate, the first address electrodes being embedded in the first dielectric layer, and the second address electrodes being embedded in the second dielectric layer.

19. The PDP as claimed in claim 18, wherein the first address electrodes are between the second substrate and the first dielectric layer, and the second address electrodes are between the first dielectric layer and the second dielectric layer.

20. The PDP as claimed in claim 17, wherein the first address electrodes are longer than the second address electrodes.
